(19) United States
(12) Patent Application Publication
(10) Pub. No.: US 2007/0244254 A1
(43) Pub. Date: Oct. 18, 2007

(54) Weatherable thermoplastic vulcanizates from polyolefins and diene or diene/vinylaromatic monomer rubbers

(76) Inventors: Tonson Abraham, Strongsville, OH (US); Norman G. Barber, Norwalk, OH (US)

Correspondence Address: ExxonMobil Chemical Company;Law Technology, P.O. Box 2149, Baytown, TX, 77522-2149, US

(21) Appl. No.: 11/402,706

(22) Filed: Apr. 12, 2006

(51) Int. Cl. C08L 53/00

(52) U.S. Cl. 525/98

(57) ABSTRACT

Low cost, highly weatherable thermoplastic vulcanizates comprising diene or diene/vinylaromatic, and preferably styrene-butadiene rubber, are taught. Weatherability; namely, UV resistance and color-fastness, is improved by the addition of carbon black. It is demonstrated that the addition of carbon black increases the UV resistance of SB rubber based TPVs to a level comparable to EPDM rubber based TPVs, while providing superior color fastness. As a result, lower cost SB rubber may be a preferable rubber for use in TPVs for exterior applications despite a lower inherent UV resistance.

### FIELD OF THE INVENTION

The present invention relates to thermoplastic vulcanizates (also referred to as thermoplastic elastomers) including thermoplastic vulcanizates derived from diene or diene/vinylaromatic rubbers and elastomer blends comprising diene or diene/vinylaromatic rubbers.

### BACKGROUND OF THE INVENTION

Thermoplastic vulcanizates (“TPVs”) are a fine dispersion of highly vulcanized rubber in a continuous phase of a polyolefin. TPVs are traditionally made by blending a rubber with a semi-crystalline polyolefin under conditions that allow for the dynamic vulcanization of the rubber. The result is a material comprised of a continuous plastic phase formed by the polyolefin and interspersed with discrete, crosslinked rubber particles, which form a rubber phase. TPVs have the benefit of the elastomeric properties provided by the rubber phase, with the thermoreversible processability of thermoplastics.

Products manufactured from TPVs are used in a variety of exterior applications. Such products may include weather-stripping, pipe seals, couplings, O-rings, mats, grips, gaskets, and a variety of building and vehicle seals and gaskets, including but not limited to hood-to-radiator seals, rocker panels, hood-to-cowl seals, cowl seals, windshield seals, sunroof seals, roof line seals, window seals, trunk and tailgate seals, quarterlight seals, cutline seals, door seals, glass channels, vehicle moldings, belt line seals, and mirror gaskets. In exterior applications, exposure to the weather, including ozone, ultraviolet (LV) radiation, and temperature and humidity variations, can materially alter the physical properties of the TPVs resulting in both aesthetic degradation and physical degradation of the product. Aesthetic degradation may materialize as discoloration; for example, the graying of a black article. Physical degradation may emerge as brittleness and increased hardness. Physical degradation can have a materially negative impact on the ability of a product to perform satisfactorily.

In many exterior applications, selection of a suitable TPV may depend less on its absolute physical properties; namely its compression set, tensile strength, color, hardness, elongation, and the like, and more on TPV's ability to retain its physical properties upon exposure to weather, including Uw radiation. For example, it may be preferable to select a TPV that better retains its tensile strength upon weathering over a TPV that has a better absolute tensile strength, but retains less of its tensile strength, proportionately, upon exposure to UV radiation. Retention of physical properties through weathering cycles is, therefore, a valuable characteristic in TPV selection, even apart from the values of the underlying physical properties.

One characteristic that is known to be related to rubber's susceptibility to weathering, and particularly UV degradation, is the degree of saturation in the rubber. Highly saturated rubbers, such as ethylene propylene diene monomer (EPDM) rubber, demonstrate better resistance to both UV degradation and ozone as measured by the retention of physical properties following exposure, than more unsaturated rubbers such as styrene butadiene (SB) rubber. See, RUBBER TECHNOLOGY HANDBOOK 164 (Hafrnann, W., Hanser/Gardner Publications, Inc., Cincinnati, Ohio, 1994). This effect is seen in both thermoset rubbers as well as TPVs. As a result, it is generally believed preferable to use highly saturated rubbers, such as EPDM rubber in exterior applications where exposure to UV radiation creates a risk of adversely affecting material properties. Thus, the seals and gaskets described above are known to be manufactured using TPVs having EPDM rubber as the primary rubber. Despite its increased susceptibility to UV degradation, SB rubber is traditionally more inexpensive than EPDM rubber and demonstrates better processability (reduced viscosity and melt pressure). For these reasons, it would be preferable in many instances to use SB rubber as the rubber component in TPVs in order to reduce material cost and increase processability.

In manufacturing TPV based articles for exterior applications, compounders must select between rubbers having such variations in weatherability, processability, and cost, amongst other factors. Given the lower cost and generally better inherent processability of SB rubber, it would be beneficial to find ways to improve the UV resistance of SB rubber, over EPDM rubber, so that SB rubber could be incorporated into TPVs for exterior applications, in place of EPDM rubber, thus resulting in lower cost articles.

In traditional thermoset rubber compounding, it is known to add carbon black as a way of improving rubber weatherability and adding bulk. See, 2 ENCYCLOPEDIA OF POLYMER SCIENCE AND ENGINEERING 633 (Kroschwitz, J. I., John Wiley and Sons, New York, N.Y., 1985). When present, carbon black absorbs UV radiation and disperses the radiation as heat, resulting in less damage to the rubber. The addition of carbon black, however, reduces processability by increasing viscosity. In TPVs, it is expected that carbon black would impart similar UV resistance to comparable thermoset rubber counterparts. It would also be expected, however, that the addition of carbon black would impart at least comparable improvement in UV resistance in EPDM rubber over SB rubber and that the overall combination of EPDM rubber with carbon black would still exhibit better overall UV resistance than SB rubber with carbon black, given the initial lower initial susceptibility of EPDM rubber to UV radiation as compared to SB rubber. Thus, the wide relative difference in UV resistance between SB rubber and EPDM rubber, in the absence of carbon black, would be expected to remain upon the addition of carbon black. UV resistance may be quantified, for purposes of comparison between TPVs, by measuring the retention of selected physical properties in TPVs after a period of exposure to UV radiation. Those physical properties may include hardness, elongation, tensile strength and color.

The present invention demonstrates that the addition of carbon black to SB rubber imparts to SB rubber based TPV's a relatively higher improvement in UV resistance, as evidenced by measuring the retention of physical properties; including tensile strength and elongation after exposure to UV radiation. As a result, the UV resistance of SB rubber based TPVs with carbon black is made comparable to the level of UV resistance found in EPDM based TPVs comprising comparable amounts of carbon black, and additionally, carbon black affords superior color-fastness to the SB rubber based TPV. As a result, by the addition of carbon black, lower cost, better processing SB rubber may be more suitable than EPDM rubber for use in TPVs for exterior applications where retention of physical properties is desirable.

The use of processing agents, most notably paraffinic oil, naphthenic oil, and aromatic process oils, to aid in the processability of TPV compositions is well documented (for example in U.S. Pat. No. 6,667,364). Such processing oils reduce viscosity during blending of the plastic and rubber TPV constituents, thus aiding the dispersion of the rubber phase in the continuous plastic phase. Further, the processing oils may be absorbed in the rubber phase of the TPV, thereby increasing the volume of material. By increasing the volume of material using relatively low cost processing oils, overall cost can be reduced. In many instances, it may be preferable to substantially saturate the TPV with processing oil in order to maximize volume and processability. However, over-saturation of the TPV with processing oil can result in oil bleed and reduction in physical properties of the rubber. It would be advantageous, therefore, to be able to determine the amount of processing oil to add in order to achieve substantial saturation of the TPV without oil bleed. Determining the optimal maximum amount of processing oil to add can prove problematic since many TPV components, particularly the elastomer components contain processing agents. The present invention discloses means for maximizing the volume of processing agents in diene and diene/vinylaromatic rubber based TPVs, including SB rubber based TPVs.

### SUMMARY OF THE INVENTION

According to one aspect of the invention, there is taught a method of producing a low cost, highly weatherable TPV; namely a TPV having good colorfastness (ΔE<3.0) and UV resistance as measured by the retention of selected physical properties following an amount of UV radiation exposure. The method may include selecting from 80% by weight to 20% by weight of the total amount of plastic plus elastomer in the TPV of a conjugated diene elastomer or unsaturated styrenic triblock copolymer having a conjugated diene rubber midblock. These are collectively referred to herein as conjugated diene rubbers. Exemplary conjugated diene rubbers may include styrene butadiene rubber, polybutadiene rubber, polyisoprene rubber, styrene/butadiene/styrene (SBS) rubber, styrene/isoprene/styrene (SIS) rubber, and blends thereof. The method may further include selecting from 20% by weight to 80% by weight of a polyolefin of the total amount of plastic plus elastomer in the TPV. Exemplary suitable polyolefins may include polyethylene, isotactic poly(1-butene), or polypropylene. The polypropylene may be isotactic or syndiotactic polypropylene. The method may additionally include selecting an amount of carbon black from 1 parts per hundred rubber (phr) to 50 phr, preferably from 5 to 50 phr, and most preferably from 20 to 50 phr, and still more preferably 40 to 50 phr, blending the elastomer and the polyolefin and blending the carbon black into at least the elastomer. The carbon black is selected and blended into at least the elastomer to improve a physical property of the thermoplastic vulcanizate, which may be colorfastness or UV resistance. The suitable amount of carbon black may be added to generate a level of UV resistance that is comparable to a TPV comprising the same amount of the polyolefin and carbon black, with EPDM rubber as the elastomer.

According to another aspect of the invention, the elastomer of the low cost, highly weatherable TPV may include at least 50% by weight, and preferably from 55% to 95% by weight, and most preferably from 60% to 75% by weight of the total elastomer a conjugated diene rubber. In another embodiment, the conjugated diene rubber may comprise as high as 99.9% by weight of the total elastomer. Exemplary conjugated diene rubbers may include styrene butadiene rubber, polybutadiene rubber, polyisoprene rubber, SIS rubber, SBS rubber and blends thereof.

According to still another aspect of the invention, the elastomer of the low cost, highly weatherable TPV may include from 0.1% to less than 50% by weight, and preferably from 5% to 45% by weight and most preferably from 25% to 40% by weight of a saturated carbon backbone rubber. Exemplary saturated carbon backbone rubbers may include EPM rubber, EPDM rubber, and rubbers selected from the class of styrenic triblock copolymers having substantially saturated backbones (defined below as SBC rubbers and explicitly distinct from unsaturated styrenic triblock copolymer rubbers such as SIS and SBS rubber). An exemplary SBC rubber is styrene/ethylene-butene/styrene triblock copolymer rubber (SEBS rubber).

According to another aspect of the invention, the polyolefin of the low cost, highly weatherable TPV may be polyethylene, isotactic poly(1-butene), or polypropylene. The polypropylene may be isotactic or syndiotactic polypropylene.

According to another embodiment of the invention, the elastomer of the low cost, highly weatherable TPV may comprise from at least 50% to 99%, and preferably from 55% to 95% and still more preferably from 60% to 75% by weight of styrene butadiene rubber and from 1% to 50% and preferably from 25% to 45% and still more preferably from 25% to 40% of EPDM rubber.

According to still another embodiment of the invention, the elastomer of the low cost, highly weatherable TPV may consist essentially of styrene butadiene rubber.

According to another aspect of the invention, the amount of the carbon black selected for use in the low cost, highly weatherable TPV may be selected to improve retention of a physical characteristics of the TPV following exposure of the TPV to UV radiation. Physical characteristics may include colorfastness, hardness, elongation, and tensile strength. In a preferred embodiment, the colorfastness of the TPVs according to the present invention (ΔE based on the Hunter Lab scale after 2500 kJ of UV exposure (“the Exposure”)) is less than 2.0 and preferably less than 1.7 and in still a more preferred embodiment, less than 1.0. In one embodiment, the tensile strength (psi) of the TPV following the Exposure is preferably at least 100% and more preferably at least 103% and most preferably at least 105% of the tensile strength of the TPV before the Exposure. Still further, in one embodiment, the elongation of the TPV following the Exposure is preferably at least 85% and more preferably at least 88% and most preferably at least 95% of the elongation of the TPV following the Exposure.

In accordance with other aspects of the invention, there are taught methods and formulations of low cost, highly weatherable thermoplastic vulcanizates that include from 20% by weight to 80% by weight, and in other embodiments, ranges described elsewhere herein, of the total amount of the plastic plus elastomer in the TPV, of an elastomer. The elastomer may be a conjugated diene rubber. The elastomer may be styrene butadiene rubber, polybutadiene rubber, SIS rubber, polyisoprene rubber, SBS rubber, or blends thereof. The thermoplastic vulcanizate may further include from 80% by weight to 20% by weight, and in other embodiments, ranges described elsewhere herein of the total amount of the plastic plus elastomer in the TPV of a suitable polyolefin; from between 1 phr to 50 phr, and preferably from 5 to 50 phr, and most preferably from 20 to 50 phr, and still more preferably 40 to 50 phr, of carbon black; and an amount of a processing agent selected to substantially saturate the thermoplastic vulcanizate without causing bleed. According to this aspect of the invention, suitable processing agents include naphthenic oil and paraffinic oil and the amount of paraffinic or naphthenic oil may be based on a vinyl weight fraction of the copolymerized butadiene in the conjugated diene rubber and a copolymerized butadiene weight fraction of the conjugated diene rubber.

### BRIEF DESCRIPTION OF THE DRAWINGS

The invention may take physical form in certain parts and arrangement of parts, a preferred embodiment of which will be described in detail in this specification and illustrated in the accompanying drawings which form a part hereof and wherein:

FIGS. 1-18 depict various articles that may be constructed with the TPVs and methods of the present invention.

FIG. 19 depicts a partial two lobe twin extruder formation.

### DESCRIPTION OF THE PREFERRED EMBODIMENT

As described herein and demonstrated in the Examples below, the addition of carbon black to TPVs consisting essentially of SB rubber as the elastomeric phase produces TPVs having comparable weatherability, defined with respect to UV resistance (as further defined with respect to retention of tensile strength and elongation following an amount of exposure to UV radiation, described herein as the Exposure) and color-fastness, to TPVs provided with the same amount of carbon black, and the same plastic, but consisting essentially of EPDM rubber as the elastomer (the “benchmark TPV”).

Accordingly, in one embodiment of the invention, low cost, highly weatherable TPVs may be formed by the method that includes the steps of selecting from 80% by weight to 20% by weight of the total amount of the plastic plus elastomer in the TPV, and preferably from 30% to 70% by weight, and most preferably from 40% to 60% by weight of one or a blend of more than one elastomer for the rubber phase of the TPV, selecting from 20% by weight to 80% by weight, and preferably from 30% to 70% by weight, and most preferably from 40% to 60% by weight of the total amount of the plastic plus elastomer in the TPV of a polyolefin or blend of polyolefins for the plastic phase of the TPV, selecting an amount of carbon black from 1 phr to 50 phr, and preferably from 5 to 50 phr and most preferably from 20 to 50 phr, and still more preferably 40 to 50 phr, and blending the elastomer, the polyolefin, and the carbon black. Amounts of carbon black greater than 50 phr up to 100 phr may be selected in accordance with the present invention.

In this and other embodiments herein, the amount of carbon black may be selected to improve a physical characteristic of the thermoplastic vulcanizate. The physical characteristic may be one or more of colorfastness following an amount of UV exposure and UV resistance and preferably colorfastness. In a preferred embodiment, the colorfastness of the TPVs according to the present invention (ΔE based on the Hunter Lab scale) is less than 3.0 and preferably less than 2.0 and in still a more preferred embodiment, less than 1.0. The amount of the Exposure is preferably 2500 kJ of UV radiation at 30 kJ per day in a weatherometer. In another embodiment, the amount of the exposure may be 1300 kJ.

The Hunter Lab scale is organized in a cube, having an L axis that runs from top to bottom, an a axis and a b axis. The maximum value of L is 100, representing a perfect reflecting diffuser. The minimum value of L is zero, representing black. Moving in a positive direction on the a axis indicates red. Moving in the negative direction on the a axis indicates green. Moving in the positive direction on the b axis indicates yellow and the negative direction indicates blue. Changes in each of these axis points, (ΔL, Δa, and Δb) are variables in determining the total color difference (ΔE). SQRT (ΔL²+Δa²+Δb²). See 8(9) HUNTER LAB APPLICATION'S NOTE August 1-15 (1996).

In one embodiment, the tensile strength (psi) of the TPV following the Exposure is preferably at least 100%, and more preferably at least 103%, and most preferably at least 105% of the tensile strength of the TPV before the Exposure. Still further, in one embodiment, the elongation of the TPV following the Exposure is preferably at least 85%, and more preferably at least 88%, and most preferably at least 95% of the elongation of the TPV before the Exposure.

In a preferred embodiment, the elastomet may comprise at least 50% by weight, and preferably from 55% to 95% by weight, and most preferably from 60% to 75% by weight of the elastomer of a conjugated diene rubber. Conjugated diene rubber may be less than 99.9% by weight of the total elastomer. Suitable conjugated diene rubbers may include diene or diene/vinylaromatic rubbers, which may include styrene butadiene (“SB”) rubber, which is preferred, polybutadiene (“PB”) rubber, polyisoprene rubber, SIS rubber, and SBS rubber. In one embodiment, the elastomer may comprise from at least 50% to 99%, and preferably from 55% to 95% and still more preferably from 60% to 75% by weight of the elastomer of styrene butadiene rubber. The elastomer may consist substantially of a single conjugated diene rubber. In a most preferred embodiment, the elastomer may consist essentially of SB rubber. The elastomer may also comprise blends of conjugated diene rubbers and/or SBC rubbers or saturated carbon backbone rubbers; however, conjugated diene rubbers preferably comprise at least 50% by weight of the elastomer.

SB rubber refers to random block copolymers of styrene and butadiene. The SB rubber may have a styrene content of between 1% to 50% by weight of the SB rubber. Styrene content of between 15% and 45%, and preferably between 20% and 40%, and still more preferably between 20% and 30% are also contemplated in accordance with the present invention. Suitable butadiene micro structures may include 1,2-butadiene, and cis and trans 1,4-butadiene. The copolymer may be prepared in any of the well known conventional cis and trans processes, such as through solution or emulsion polymerization. The weight percent of the butadiene in the SB rubber may range from 50% by weight to 99% by weight. Weight percents of butadiene in the SB rubber of between 85% and 55%, and preferably between 80% and 60%, and still more preferably between 80% and 70% are contemplated in accordance with the present invention. Larger or smaller amounts of butadiene may be employed. The butadiene portion may contain from 10% to 90% of 1,2-polybutadiene, with the remainder consisting essentially of cis and trans 1,4-polybutadiene. The ratio of cis to trans isomers in the 1,4-polybutadiene may be between 0.2 and 0.65. The molecular weight, on a number average value, may be from 30,000 to greater than one million. The exemplary solution SB rubber used in the compositions set forth in the examples is VSL 5025-0HM, manufactured by Lanxess Corp.

PB rubber refers to homopolymers of butadiene having a cis-1,4 butadiene content as low as 5% to as high as 98% by weight. PB rubber also refers to homopolymers of butadiene having a vinyl-1,2 butadiene content as low as 2% and as high as 90% by weight. As discussed above, and described in further detail below, it has been discovered that the capacity of PB rubber and SB rubbers to hold processing agents is determined by the vinyl content of the polybutadiene. The molecular weight, on a number average value, may be from 30,000 and greater than one million.

Polyisoprene rubber refers to homopolymers of isoprene, including natural rubber. Polyisoprene rubber may have a cis-content as low as 5% to as high as 98% by weight. The molecular weight, on a number average value, may be from 30,000 and greater than one million.

As indicated above, the elastomer of the present invention may comprise a blend of two or more rubbers. Preferably, in such an embodiment, the blend comprises at least 50% of a conjugated diene, including unsaturated styrenic triblock copolymer rubber, or diene vinylaromatic rubber and most preferably, at least 50% of SB rubber, though it is recognized above that in other embodiments, the conjugated diene rubber in the blend may comprise greater than 55% or 60% by weight of the total elastomer in the TPV. Other suitable rubbers, which may be used in the elastomer as part of the rubber blend, in amounts from 0.1% to less than 50%, and preferably from 25% to 45% and still more preferably from 25% to 40% by weight may include EPM rubber, EPDM rubber, and SBC rubber, with EPDM rubber being preferred

EPM rubber refers to an ethylene-propylene copolymer rubber which can be cross-linked by radiation curing or peroxide curing.

EPDM rubber refers to a terpolymer of ethylene, propylene and a non-conjugated diene. Illustrative non-limiting examples of suitable non-conjugated dienes are 5-ethylidene-2-norbornene (ENB); 1,4-hexadiene; 5-methylene-2-norbomene (MNB); 1,6-octadiene; 5-methyl-1,4-hexadiene; 3,7-dimethyl-1,6-octadiene; 1,4-cyclohexadiene; tetrahydroindene; methyltetrahydroindene; dicyclopentadiene; 5-isopropylidene-2-norbomene; 5-vinyl- norbomene; etc. The ethylene content of the EPDM rubber may be from 25% to 80% by weight. Weight percents of the ethylene in the EPDM rubber of between 30% and 70%, and preferably 45% and 65%, and still more preferably 50% and 60% are contemplated in accordance with the present invention. The non-conjugated diene content may be from 2% to 10% by weight, with the remaining content being substantially polypropylene. The molecular weight, on a number average value, may be from 30,000 and greater than one million. The exemplary EPDM rubber used in the compositions set forth in the examples is V3666 (EP(ENB)DM) manufactured by ExxonMobil.

SBC rubber refers to hydrogenated styrenic triblock copolymer elastomers, exemplified by SEBS (styrene/ethylene-butene/styrene), SEPS (styrene/ethylene-propylene/styrene), SEEPS (styrene/ethylene-ethylene-propylene/styrene) are widely commercially available and are described in further detail in U.S. Patent Application Pub. No. 2004/0132907. As noted in the aforementioned reference, hydrogenated styrenic triblock copolymers may include crosslinkable styrenic blocks, which, in combination with the crosslinkable midblocks, may afford greater overall crosslinking of the cured elastomer within the TPV. These elastomers may have a styrene content as low as 10% by weight to as high as 50% by weight, preferably 20% and 40% by weight, and most preferably from 25% to 35% by weight. The molecular weight of the styrene component may be from 7,000 to 50,000 and the molecular weight of the elastomeric component may be from 30,000 to greater than 150,000. Methods of forming suitable hydrogenated styrenic triblock copolymer elastomers are well known in the art. See, Styrenic Thermoplastic Elastomers, in THERMOPLASTIC ELASTOMERS Ch. 3 (G. Holden, N. R. Legge, R. Quirk, and H. E. Schroeder eds., Hauser/Gardner Publications, Inc., Cincinnati, Ohio, 1996). It is noted that styrene isoprene styrene (SIS) rubber and styrene butadiene styrene (SBS) rubber are not within the scope of SBC rubbers for purposes of this application, but are referred to collectively as unsaturated styrenic triblock copolymer rubbers having a conjugated diene rubber midblock.

In another embodiment of the invention, the elastomer may be a blend including conjugated diene rubbers and saturated carbon backbone rubbers. The amount of saturated carbon backbone rubbers in the blend may be from 0.1% by weight, and preferably 5% by weight to less than 50% by weight, though in other embodiments, the amount of saturated carbon backbone rubbers may be from 5% to 45% by weight, and preferably 25% to 40% by weight. In a preferred embodiment, the saturated carbon backbone rubber is EPDM, which may be added to improve ozone resistance in the resultant thermoplastic vulcanizate. In another embodiment, the amount of EPDM may be from 5% to 45%. In still another embodiment, the amount of EPDM may be 25% to 40%. The EPDM rubber may be incorporated into the elastomer blend to improve ozone resistance. In still other embodiments, EPM rubber may be used in place of all or a portion of the EPDM rubber in the selected elastomer. In still other embodiments, styrenic triblock copolymer elastomers may be used in a blend with SB rubber. In this embodiment, the styrenic triblock copolymer elastomer may comprise from 0.1% by weight to 50% by weight of the elastomer though it will be appreciated that ranges of 5% to 45% and 25% to 40% by weight may be used in accordance with the invention. In other embodiments, the selected elastomer may be PB rubber, polyisoprene rubber, SIS rubber, SBS rubber or blends of these rubbers rubber with one or more of EP, EPDM, SEBS, SEPS, or SEEPS rubber. It is noted that the possible blends of elastomers that may be used according to the present invention are numerous and not all are specifically recorded herein.

Suitable polyolefins include isotactic polypropylene (“iPP”), homopolymers of ethylene, including high density polyethylene, low density polyethylene, very low density polyethylene, ethylene/propylene copolymer, ethylene/1-butene copolymer, ethylene/i-hexene copolymer, ethylene/1-octene copolymer (collectively, the polyethylene homopolymers and copolymers are referred to as “polyethylene” unless otherwise stated); isotactic poly(1-butene) and copolymers of 1-butene with ethylene, propylene, 1-hexene, or 1-octene (collectively, the isotactic poly(1-butene) homopolymers and copolymers are referred to as “isotactic poly(1-butene” unless otherwise stated); and syndiotactic polypropylene and copolymers of syndiotactic propylene with ethylene, 1-butene, 1-hexene, or 1-octene (collectively, the syndiotactic propylene homopolymers and copolymers are referred to as “syndiotactic propylene” unless otherwise stated), ands blends of the aforementioned. In a preferred embodiment, the polyolefin is iPP.

Suitable carbon blacks include carbon blacks of all ASTM designations.

A selected amount of a processing agent may be added to the TPV, before or during the blending stage. Suitable processing agents may include naphthenic oil and paraffinic oil. In one embodiment, from 0 to 200 phr of processing agent may be added to the TPV, which may be above the amounts present in the constituent rubber component. In another embodiment, an amount of processing agent selected to substantially saturate the TPV without resulting oil bleed may be added.

Where the elastomer selected for the TPV is a diene/vinylaromatic rubber, such as SB rubber, it has been discovered that the amount of paraffinic or naphthenic oil that can be held by the resultant TPV without oil bleed (the “oil holding capacity”) bears a relation to the vinyl weight fraction of the diene and the diene weight fraction in the rubber. The vinyl weight fraction refers to the weight fraction of the vinyl isomer in the diene to the total weight of the diene, which may be the sum of the cis, trans, and vinyl isomers.

In accordance with this discovery, the oil holding capacity (parts per hundred rubber) of TPVs having iPP, isotactic poly (1-butene) or syndiotactic polypropylene as the plastic and SB rubber as the elastomer may be determined by the formula:
BD°[66+(V−0.15)°68]

Wherein BD is the weight fraction of copolymerized butadiene in the SB rubber and V is the vinyl weight fraction of the copolymerized butadiene.

In TPVs having polyethylene as the plastic and SB rubber as the elastomer, the oil holding capacity may be determined by the formula:
BD°[46.7+(V−0.15)°68]

When a TPV contains a blend of PE and iPP (or iPB or sPP) as the plastic and SB rubber as the elastomer, the oil holding capacity may be determined by interpolating between the above referenced formulas.

In addition to an amount of processing agent, various fillers, such as carbon black and clay, antioxidants, antiozonants, stabilizers, lubricants (e.g., oleamide), antiblocking agents, antistatic agents, waxes, coupling agents for the fillers, foaming agents, pigments, fire retardants, titanium dioxide, talc, and other similar materials may be selected and blended into the TPV, in amounts that are well known in the art of compounding.

The method of forming low cost, highly weatherable TPVs may further include the step of dynamically vulcanizing the elastomer. Suitable curing methods may include peroxide cure, sulfur cure, resin cure, and hydrosilylation cure. The curing method selected may depend on the TPV formulation as it is known that certain elastomers will respond more efficiently to specific curing methods. Suitable curing agents and co-agents may be used in amounts that are well known in the art.

In a preferred embodiment, the elastomer may be fully cured. The term “fully cured” or “fully vulcanized” relative to the dynamically vulcanized rubber component of this invention denotes that the rubber component to be vulcanized has been cured to a state in which the physical properties of the rubber are developed to impart elastomeric properties to the rubber generally associated with the rubber in its conventional vulcanized state. The degree of cure of the vulcanized rubber can be described in terms of extractable components. Using this measure of the degree of cure, the improved thermoplastic elastomeric compositions may be produced by vulcanizing the curable rubber component of the blends to the extent that the composition contains no more than 6 percent by weight of the cured rubber component extractable at room temperature by a solvent which dissolves the rubber which is intended to be vulcanized, and preferably to the extent that the composition contains less than three percent by weight extractable.

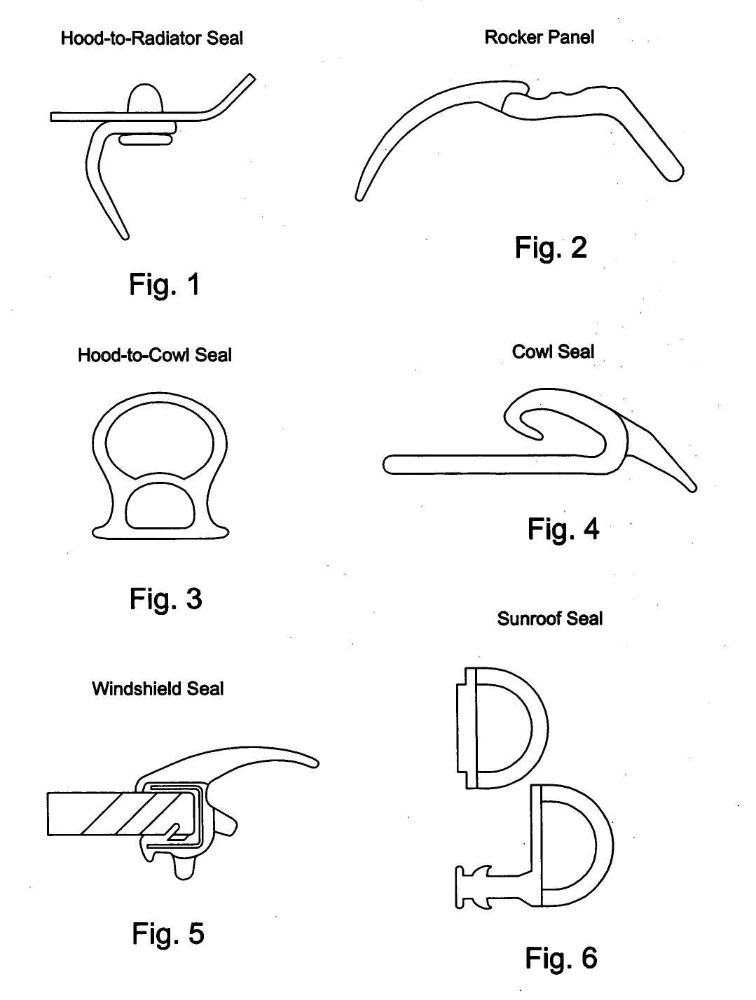

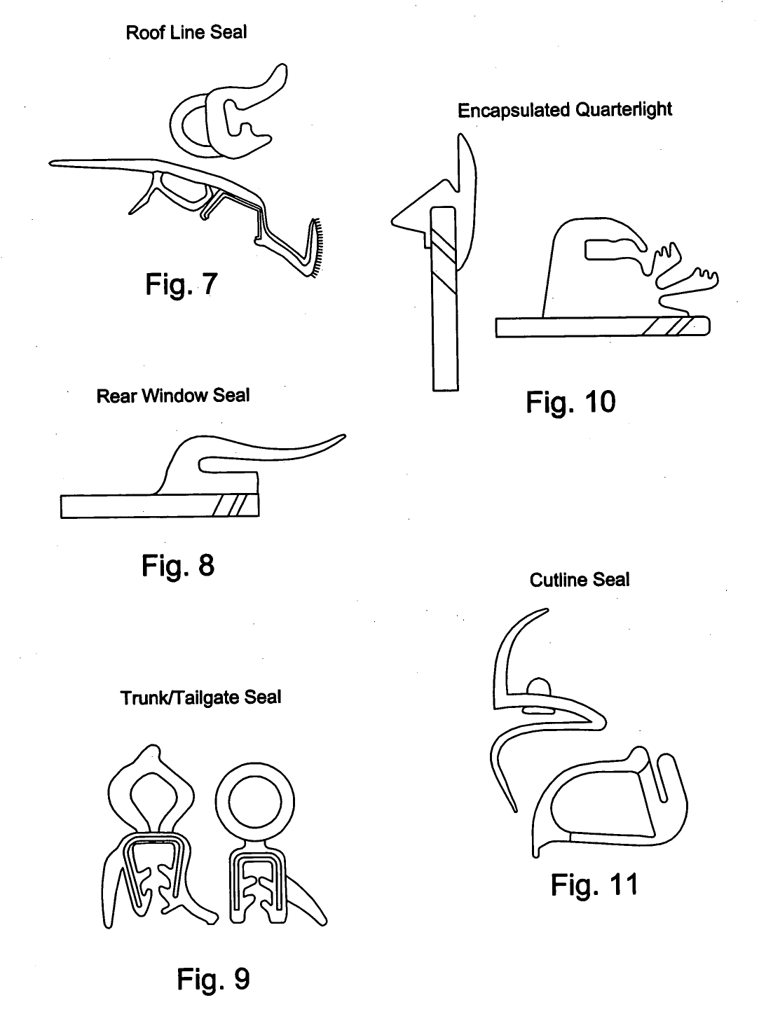

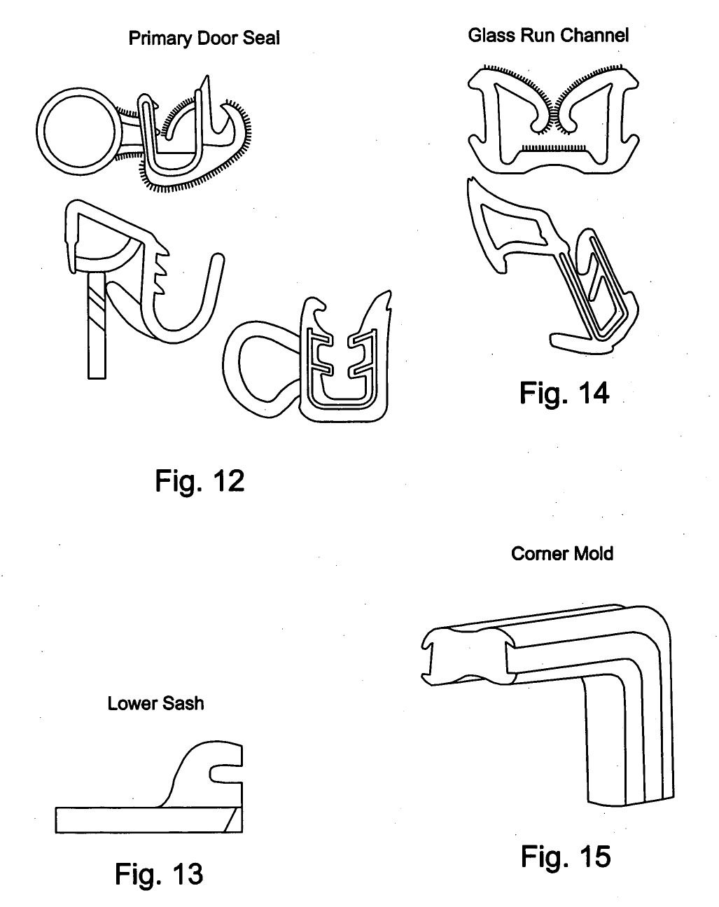

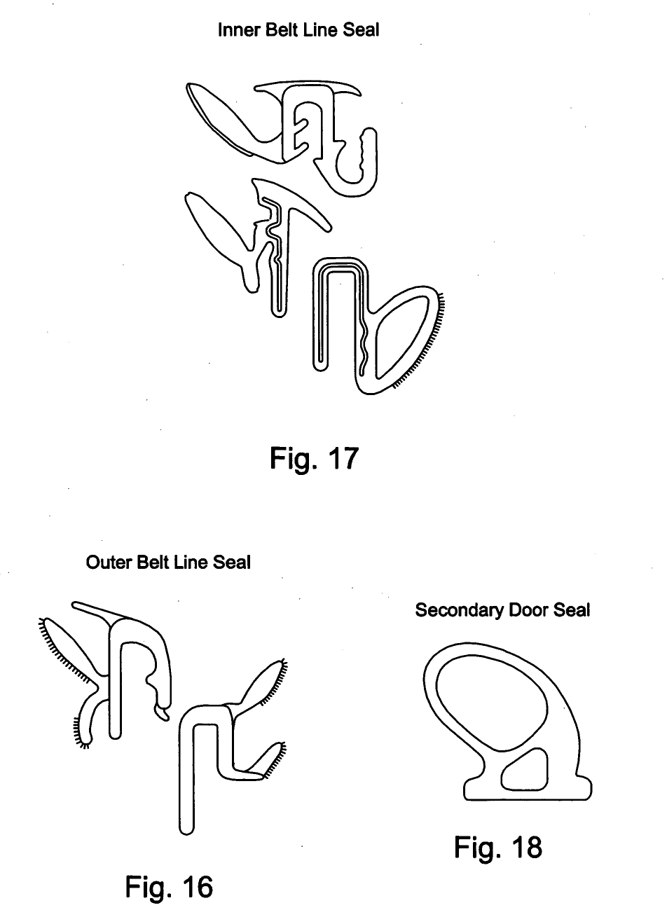

The structure of products formulated from EPDM rubber based TPVs and used in applications where exposure to UV radiation is likely are well described in the literature, such as, for example, in product brochures entitled “Residential Glazing and Weather Seals”, “Automotive Molded Seals Solutions”, and “Drive Innovation,” available from Advanced Elastomer Systems, Inc. (published 2000 to 2005). Such products may include weather-stripping, pipe seals, couplings, O-rings, mats, grips, such as handle grips, and gaskets and seals for automotive and building applications. FIGS. 1-18 depict a wide variety of gaskets and seals used in automotive applications. It should be understood that the depictions in the FIGURES are 2-dimensional profiles of 3-dimensional objects. The FIGURES are intended to be representative of some of the types of seals and gaskets that are presently manufactured using benchmark TPVs. The 3-dimensional structures depicted in the FIGURES are well known in the art and it is not within the scope of this invention to be limited to any particular structure, though it will be readily understood that each of these articles may be constructed either wholly or in-part from the TPVs described herein.

As indicated above, the article may be weather-stripping, pipe seal, couplings, O-rings, mats, grips, or gaskets. In still another embodiment, the article may be an automotive seal or gasket.

In support of the discovery disclosed herein relating to the selective effect of carbon black on UV resistant and weatherability in diene and diene vinylaromatic based TPVs, the following Examples are offered.

For purposes of the Examples, the following materials were used:

| | |
|---|---|
| Rubbers | |
| SBR VSL | Bayer Solution SBR, 25 wt % bound styrene, |
| 5025-0 HM | 75 wt % bound butadiene. |
| | Butadiene microstructure: 65.5% vinyl, |
| | 14.1% cis, 20.4% trans. |
| V3666 | ExxonMobil EP(ENB)DM: 64 wt % ethylene, |
| | 3.9 wt % ethylidenenorbornene, |
| | 75 phr paraffinic oil. |
| VSL N330/105 | Rubber Masterbatch: 100 phr VSL 5025-0 |
| Pellet | HM, 10 phr N330 black, 5 phr |
| | Sunpar 150M paraffinic oil. |
| VSL N330/505 | Rubber materbatch: |
| Pellet | 100 phr VSL 5025-0 HM, 50 phr N330 |
| | black, 5 phr Sunpar 150M paraffinic oil. |
| V3666 MB | Rubber masterbatch: |
| | 175 phr V3666, 50 phr N330 black. |
| P597 | DSM EP(ENB)DM: 63 wt % ethylene, 4.4 wt % |
| | ethylidenenorbornene, 0.2 wt % |
| | vinylnorbornene, 100 phr paraffinic oil. |
| Plastic Materials | |
| PP51S07A | Sunoco 0.8 MFR iPP homopolymer |
| HD 6706:19 | ExxonMobil 7.0 MI HDPE |
| Rubber Curatives | |
| SP 1045 | Schenectady “resole” type phenolic resin |
| SMD 31214 | Schenectady: 30 wt % solution of a |
| | “resole” type phenolic resin in |
| | paraffinic oil. |
| Catalyst for | |
| Rubber Curative | |
| SnCl₂, SnCl₂•2H₂0 | Cure promoter |
| ZnO | Scorch retarder and heat stabilizer |
| Other Materials | |
| Sunpar 150, | Sunoco paraffinic oil |
| Sunpar 150M | |
| Icecap K Clay | Burgess calcined clay. |
| N330 black | Degussa |

### EXAMPLE 1

In Example 1, carbon black (N330) was blended into Bayer oil free SBR 5025-0 HM at 10 and 50 phr levels (Sample 1 and Sample 2 respectively in Table 1) in a Banbury. In both cases, 5 phr of paraffinic oil was added during rubber masterbatch preparation in order to facilitate black dispersion. The rubber masterbatches were then pelletized. A rubber masterbatch of V3666 EPDM containing 50 phr of N330 carbon black was also prepared in a similar manner (Control). Due to the oil extended EPDM rubber used (75 phr of paraffinic oil), no additional oil was necessary in blend preparation.

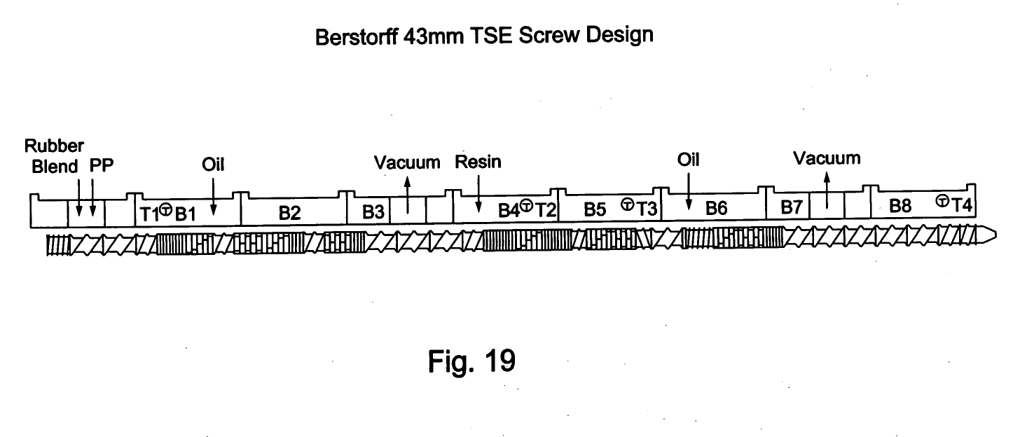

TPVs were then prepared in a Berstorff 43 mm two lobe twin screw extruder with eight barrel sections such as is depicted in FIG. 19, (which shows one half of the twin screw design) using the rubber masterbatches with iPP as plastic phase, and phenolic resin as curative as per the formulations in Table 1. Sample 1 was prepared at 200 revolutions per minute (rpm) at 50 kg/hr. Samples 2 and 3 were prepared at 400 rpm at 50 kg/hr. The final oil extension in all the SB rubber based TPVs was 75 phr (60.20 phr was added during the process, 9.8 phr came from the solution of the phenolic resin curative in paraffinic oil, and 5 phr from rubber masterbatch preparation). The TPVs produced with EPDM rubber contained 84.8 phr of paraffinic oil (75 phr from the oil extended rubber and 9.8 phr from the phenolic resin curative solution).

TABLE 1
TPV Formulations For Example 1

| | Example | | |
|---|---|---|---|
| | Sample 1 | Sample 2 | Control |
| VSL N330/105(SBR)¹ | 115 | | |
| VSL N330/505(SBR)² | | 155 | |
| V3666 BMB³ | | | 225 |
| Sunpar 150M | 60.2 | 60.2 | |
| PP51S07A | 40.0 | 40.0 | 40.0 |
| SnCl₂ | 1.50 | 1.50 | 1.50 |
| ZnO | 2.00 | 2.00 | 2.00 |
| SMD31214 | 14.0 | 14.0 | 14.0 |

¹Blend of 100 parts SB rubber; 10 parts carbon black; 5 parts oil.
²Blend of 100 parts SB rubber; 50 parts carbon black; 5 parts oil.
³Blend of 100 parts EPDM rubber; 50 parts carbon black; 75 parts oil.

Injection molded plaques obtained from the Sample and Control formulations of Table 1 were subjected to 2500 kJ of UV exposure in a weatherometer that simulated night, day, and rainy conditions (30 kJ/day). As demonstrated from the data in Table 2, the physical property retention for the SB rubber based TPV products were comparable to that of the EPDM based TPV after weathering (% retention of tensile strength of 105% versus 104%); (% retention of elongation of 88% versus 103%; % retention of modulus of 120% versus 108%). The color stability of the SB rubber TPVs was superior to that of the EPDM TPV (ΔE of 0.97 versus 3.64). Color measurements (ΔE) are derived according to the Hunter Lab color scale.

TABLE 2
Weathering Test Data for Example 1

| | Example | | |
|---|---|---|---|
| | Sample 1 | Sample 2 | Control |
| Hardness (Shore A) | 65 | 64 | 69 |
| UTS (psi) | 745 | 828 | 1464 |
| UE (%) | 217 | 194 | 357 |
| M100 (psi) | 463 | 501 | 536 |
| Change in Hardness | +6 | +5 | +1 |
| % Retention | | | |
| UTS | 103 | 105 | 104 |
| UE | 96 | 88 | 103 |
| M100 | 108 | 120 | 108 |
| Color Change (ΔE) | 1.69 | 0.97 | 3.64 |

### EXAMPLE 2

To test the effect on weathering when SB rubber is partially replaced with EPDM rubber, a masterbatch (MB) was prepared according to the formulation in Table 3 to include 70 parts of SB rubber and 30 parts of EPDM—representing a 30% replacement of SB rubber with EPDM. Masterbatch preparation was carried out under nitrogen in a laboratory Brabender-Plasticorder, model EPL - V5502. The mixing bowls had a capacity of 85 ml with the cam-type rotors employed. The SB rubber and EPDM rubber were melt blended in the mixing bowl that was heated to 180° C. and at 100 rpm rotor speed. After blending for 2.5 minutes, 50 parts of carbon black was blended into the rubber for 2.25 minutes. An amount of paraffinic oil was packed into the mixer over a period of 1.25 minutes. Following addition of the oil, the masterbatch was blended an additional 2.25 minutes.

Preparation of the TPV labeled Sample 3 in Table 3 involved melting in Brabender 24 parts of iPP and 16 parts of PE at 180° C. and at 100 rpm rotor speed over a period of 1 minute. Thereafter the amounts of masterbatch MB, described above, and tin chloride, were added to the plastic and mixed for 3 minutes. Thereafter, the curative agent (phenolic resin) was added and mixing continued for 3 minutes. The molten TPV was removed from the mixer, and pressed when hot between Teflon plates into a sheet that was cooled, cut-up, and compression molded at 400° F. A Wabash press, model 12-1212-2 TMB was used for compression molding, with 4.5″×4.5″×0.06″ mold cavity dimensions in a 4-cavity Teflon-coated mold. Material in the mold was initially preheated at 400° F. for 2-2.5 min. at a 2-ton pressure on a 4″ ram, after which the pressure was increased to 10-tons, and heating was continued for 2-2.5 min. more. The mold platens were then cooled with water, and the mold pressure was released after cooling (140° F.).

Dog-bones were cut out of the molded (aged at room temperature for 24 hr.) plaque for tensile testing (0.16″ width, 1.1″ test length (not including tabs at end)).

TABLE 3
TPV Formulations For Example 2

| | MB | Sample 3 |
|---|---|---|
| VSL 5025-0 | 70.00 | |
| P597 | 60.00 | |
| N 330 | 50.00 | |
| Sunpar 150M | 52.50 | |
| MB | | 232.50 |
| PP51S07A | | 24.00 |
| HD 6706.19 | | 16.00 |
| SnCl2•2H2O | | 1.80 |
| SP1045P | | 8.00 |
| Total | 232.50 | 282.30 |

As demonstrated in Table 4, the retention of physical properties following UV exposure (1300 kJ) is observed when 30% by weight of the SB rubber in the total elastomer is replaced with EPDM as per the formulation of Table 3. Color measurements (L, a, b, and ΔE) are derived according to the Hunter Lab color scale. After exposure to 1300 kJ of UV radiation, the tensile strength was 99% retained, the elongation was 98% retained, the modulus was 102% retained and ΔE (unwashed and washed) were 2.2 and 1.2 respectively.

For comparative purposes, the retention of physical properties of a commercially available 64 shore A hardness iPP/EPDM TPV sold under the tradename Santoprene 101-64 by Advanced Elastomer Systems, LP similarly exposed to 1300 kJ of UV radiation are presented in Table 4.

TABLE 4
Weathering Test Data for Example 2

| | | Santoprene |
|---|---|---|
| | Sample 3 | 101-64 |
| Original | | |
| Hardness (Shore A) | 67 | 63 |
| UTS (psi) | 912 | 908 |
| Elong % | 170 | 337 |
| M 100 (psi) | 586 | 436 |
| WEATHEROMETER | | |
| 1300 KJ | | |
| Change in Hardness | +1 | 0 |
| Retention % | | |
| UTS | 99 | 78 |
| Elongation | 98 | 78 |
| M 100 | 102 | 101 |
| COLOR CHANGE | | |
| Original | | |
| L | 13.35 | 14.78 |
| a | −0.02 | −0.01 |
| b | −0.80 | −0.75 |
| Aged 1300 KJ (Unwashed) | | |
| L | 15.59 | 22.07 |
| a | −0.04 | −0.09 |
| b | −0.57 | −0.47 |
| ΔE | 2.2 | 7.3 |
| Aged 1300 KJ (Washed) | | |
| L | 14.57 | 20.64 |
| a | −0.03 | −0.09 |
| b | −0.62 | −0.63 |
| ΔE | 1.2 | 5.9 |

### EXAMPLE 3

To demonstrate the effect of carbon black on processability, TPVs according to the formulations in Table 1 were prepared in a Berstorff 43 mm two lobe twin screw extruder with eight barrel sections, excluding a feed barrel at the head of the extruder (L/D=5 per barrel) as shown in FIG. 19. The twin screw tip was followed by a diverter valve and die (not shown in the barrel and screw design schematic representation of FIG. 1). The extrudate from the die was fed to an underwater pelletizer. Melt temperature probes were attached to barrels B, (T₁), B₄ (T₂), B₅ (T₃), and B₈ (T₄). A melt pressure probe was attached to barrel B₆. The externally added oil was split between B1 (15.2 phr before cure) and B6 (45.0 phr after cure) for SB rubber TPV preparation.

As shown in Table 5, all the SB rubber based black filled TPV formulations of Table 1, were much more readily processable (i.e., had a lower melt viscosity) than the EPDM based black filled TPV. Specifically, the melt temperatures and pressure of comparable formulations Sample 2 and Control (Table 1) were better for the SB rubber based Sample 2 than the EPDM based Control. On increasing the carbon black level in SB rubber formulations from 10 phr to 50 phr (Sample 1 and Sample 2 respectively), the TPV melt pressure changed from 1535 to only 1615 psi, where as in the EPDM rubber TPV, at 50 phr carbon black loading, the melt pressure was 2840 psi. All the TPV compositions containing SBR could be blow molded. The EPDM containing composition (Control) yielded a torn part with a rough surface on attempted blow molding, presumably due to one or a combination of the high TPV melt viscosity or poor materials dispersion in the molten TPV.

TABLE 3
Processability Data

| | Sample 1 | Sample 2 | Control |
|---|---|---|---|
| T 3 (° C.) | 233 | 263 | 236 |
| T 4 (° C.) | 202 | 221 | 278 |
| Melt Pressure (psi) | 1535 | 1615 | 2840 |

The Examples demonstrate that despite the generally higher initial UV resistance of EPDM rubber to SB rubber, the addition of carbon black improves the UV resistance of SB rubber based TPVs as compared to EPDM rubber based TPVS in a manner that renders SB rubber based TPVs with carbon black comparable to EPDM rubber based TPVs with similar amounts of carbon black. SB rubber based TPVs with carbon black demonstrate superior color-fastness as compared to comparable EPDM rubber based TPVs. The processability advantages of TPVs based on SB rubber remain. Accordingly, low cost, highly weatherable TPVs may be developed for use in applications where exposure to UV radiation may prove detrimental to the physical properties of the article.

The preferred embodiments have been described, hereinabove. It will be apparent to those skilled in the art that the above methods may incorporate changes and modifications without departing from the general scope of this invention. It is intended to include all such modifications and alterations in so far as they come within the scope of the appended claims or the equivalents thereof.
1. One aspect of the invention can be described as a thermoplastic vulcanizate comprising:
   from 80% by weight to 20% by weight of an elastomer, wherein the elastomer comprises at least 50% by weight of a conjugated diene rubber, selected from the group consisting of styrene butadiene rubber, polybutadiene rubber, styrene/isoprene/styrene rubber, polyisoprene rubber, and styrene/butene/styrene rubber, and blends thereof,
   from 20% by weight to 80% by weight of a polyolefin;
   from 1 phr to 50 phr of carbon black; and
   an amount of a processing agent based on a vinyl weight fraction of the copolymerized butadiene in the styrene butadiene rubber and a copolymerized butadiene weight fraction of the styrene butadiene rubber.
2. The weatherable thermoplastic vulcanizate of numbered embodiment 1, wherein the conjugated diene rubber consists essentially of styrene butadiene rubber;
   wherein the polyolefin is selected from the group consisting of isotactic polypropylene, syndiotactic polypropylene, and isotactic poly(1-butene);
   wherein the processing agent is selected from the group consisting of naphthenic oil and paraffinic oil; and
   wherein the amount of the processing agent is selected according to the formula BD [66+(V-0.15) 68], wherein BD is the weight fraction of copolymerized butadiene in the styrene butadiene rubber and V is the vinyl weight fraction of the copolymerized butadiene.
3. The weatherable thermoplastic vulcanizate of either of embodiments 1 and 2, characterized in possessing a ΔE of less than 1.0, wherein the ΔE is calculated based on an exposure to 2500 kJ of ultraviolet radiation at a rate of 30 kJ per day.
4. The weatherable thermoplastic vulcanizate of any of the preceding numbered embodiments, wherein the conjugated diene rubber consists essentially of styrene butadiene rubber;
   wherein the polyolefin consists essentially of polyethylene;
   wherein the processing agent is selected from the group consisting of napthenic oil and paraffinic oil; and
   wherein the amount of the processing agent is selected according to the formula BD°[46.7+(V-0.15)°68], wherein BD is the weight fraction of copolymerized butadiene in the styrene butadiene rubber and V is the vinyl weight fraction of the copolymerized butadiene.
5. The thermoplastic vulcanizate of any of the preceding numbered embodiments, wherein the elastomer comprises from 0.1% to less than 50% by weight of a saturated backbone rubber selected from the group consisting of EPM rubber, EPDM rubber, and SBC rubber.
6. The thermoplastic vulcanizate of any of the preceding numbered embodiments, wherein the thermoplastic vulcanizate retains at least 100% of its tensile strength following the exposure to 2500 kJ of ultraviolet radiation at a rate of 30 kJ per day
7. Another aspect of the invention can be described an article comprising the thermoplastic vulcanizate of any of the preceding numbered embodiments, wherein the article is selected from the group consisting of hood-to-radiator seals, rocker panels, hood-to-cowl seals, cowl seals, windshield seals, sunroof seals, roof line seals, window seals, trunk and tailgate seals, quarterlight seals, cutline seals, door seals, glass channels, vehicle moldings, belt line seals, and mirror gaskets.
8. Another aspect includes a method of preparing a thermoplastic vulcanizate, the method comprising:
   selecting from 80% by weight to 20% by weight of an elastomer, wherein the elastomer comprises at least 50% by weight of a conjugated diene rubber, selected from the group consisting of styrene butadiene rubber, polybutadiene rubber, styrene/isoprene/styrene rubber, polyisoprene rubber, and styrene/butene/styrene rubber, and blends thereof;
   selecting from 20% by weight to 80% by weight of a polyolefin selected from the group consisting of polyethylene, isotactic poly(1-butene), and polypropylene;
   selecting an amount of carbon black from 1 phr to 50 phr;
   blending the carbon black into at least the elastomer; and
   forming the thermoplastic vulcanizate.
9. Yet another aspect of the invention is to the use of a thermoplastic vulcanizate comprising:
   from 80% by weight to 20% by weight of an elastomer, wherein the elastomer comprises at least 50% by weight of a conjugated diene rubber, selected from the group consisting of styrene butadiene rubber, polybutadiene rubber, styrene/isoprene/styrene rubber, polyisoprene rubber, and styrene/butene/styrene rubber, and blends thereof;
   from 20% by weight to 80% by weight of a polyolefin;
   from 1 phr to 50 phr of carbon black; and
   an amount of a processing agent based on a vinyl weight fraction of the copolymerized butadiene in the styrene butadiene rubber and a copolymerized butadiene weight fraction of the styrene butadiene rubber.

We claim:

1. A method of preparing a thermoplastic vulcanizate, the method comprising:
selecting from 80% by weight to 20% by weight of an elastomer, wherein the elastomer comprises at least 50% by weight of a conjugated diene rubber, selected from the group consisting of styrene butadiene rubber, polybutadiene rubber, styrene/isoprene/styrene rubber, polyisoprene rubber, and styrene/butene/styrene rubber, and blends thereof;
selecting from 20% by weight to 80% by weight of a polyolefin selected from the group consisting of polyethylene, isotactic poly(1-butene), and polypropylene;
selecting an amount of carbon black from 1 phr to 50 phr;
blending the carbon black into at least the elastomer; and
forming the thermoplastic vulcanizate, wherein the thermoplastic vulcanizate has a ΔE of less than 2.0, wherein the ΔE is calculated based on an exposure to 2500 kJ of ultraviolet radiation at a rate of 30 kJ per day.

2. The method of claim 1, wherein the elastomer comprises at least 70% by weight of a conjugated diene rubber;
wherein the amount of carbon black selected is from 40 to 50 phr; and
wherein the thermoplastic vulcanizate has a ΔE of less than 1.0, wherein the ΔE is calculated based on the exposure to 2500 kJ of ultraviolet radiation at a rate of 30 kJ per day.

3. The method of claim 2, wherein the thermoplastic vulcanizate retains at least 100% of its tensile strength following the exposure to 2500 kJ of ultraviolet radiation at a rate of 30 kJ per day.

4. The method of claim 3, wherein the elastomer comprises from at least 50% to 99% by weight of styrene butadiene rubber and from 1% to less than 50% of EPDM rubber.

5. The method of claim 3, wherein the elastomer consists essentially of styrene butadiene rubber.

6. The method of claim 5, further comprising the steps of:
selecting an amount of a processing agent based on a vinyl weight fraction of the of copolymerized butadiene in the styrene butadiene rubber and a copolymerized butadiene weight fraction of the styrene butadiene rubber, wherein the amount of the processing agent is selected to achieve oil saturation of the TPV; and
blending the amount of the processing agent with the elastomer, the polyolefin and the carbon black.

7. The method of claim 6, wherein the polyolefin is selected from the. group consisting of isotactic polypropylene, syndiotactic polypropylene, and isotactic poly(1-butene);
wherein the processing agent is selected from the group consisting of napthenic oil and paraffinic oil; and
wherein the amount of the processing agent is selected according to the formula BD [66+(V-0.15) 68], wherein BD is the weight fraction of copolymerized butadiene in the styrene butadiene rubber and V is the vinyl weight fraction of the copolymerized butadiene.

8. The method of claim 6, wherein the polyolefin consists essentially of polyethylene;
wherein the processing agent is selected from the group consisting of napthenic oil and paraffinic oil; and
wherein the amount of the processing agent is selected according to the formula BD [46.7+(V-0.15) 68], wherein BD is the weight fraction of copolymerized butadiene in the styrene butadiene rubber and V is the vinyl weight fraction of the copolymerized butadiene.

9. A thermoplastic vulcanizate comprising:
from 80% by weight to 20% by weight of an elastomer, wherein the elastomer comprises at least 50% by weight of a conjugated diene rubber, selected from the group consisting of styrene butadiene rubber, polybutadiene rubber, styrene/isoprene/styrene rubber, polyisoprene rubber, and styrene/butene/styrene rubber, and blends thereof;
from 20% by weight to 80% by weight of a polyolefin;
from 1 phr to 50 phr of carbon black; and
an amount of a processing agent based on a vinyl weight fraction of the copolymerized butadiene in the styrene butadiene rubber and a copolyrnerized butadiene weight fraction of the styrene butadiene rubber.

10. The weatherable thermoplastic vulcanizate of claim 9, wherein the conjugated diene rubber consists essentially of styrene butadiene rubber;
wherein the polyolefin is selected from the group consisting of isotactic polypropylene, syndiotactic polypropylene, and isotactic poly(1-butene);
wherein the processing agent is selected from the group consisting of naphthenic oil and paraffinic oil; and
wherein the amount of the processing agent is selected according to the formula BD [66+(V-0.15) 681, wherein BD is the weight fraction of copolymerized butadiene in the styrene butadiene rubber and V is the vinyl weight fraction of the copolymerized butadiene.

11. The weatherable thermoplastic vulcanizate of claim 9, having a ΔE of less than 1.0, wherein the ΔE is calculated based on an exposure to 2500 kJ of ultraviolet radiation at a rate of 30 kJ per day.

12. The weatherable thermoplastic vulcanizate of claim 9, wherein the conjugated diene rubber consists essentially of styrene butadiene rubber;
wherein the polyolefin consists essentially of polyethylene;
wherein the processing agent is selected from the group consisting of napthenic oil and paraffinic-oil; and
wherein the amount of the processing agent is selected according to the formula BD°[46.7+(V-0.15)°68], wherein BD is the weight fraction of copolymerized butadiene in the styrene butadiene rubber and V is the vinyl weight fraction of the copolymerized butadiene.

13. The thermoplastic vulcanizate of claim 9 wherein the elastomer comprises from 0.1% to less than 50% by weight of a saturated backbone rubber selected from the group consisting of EPM rubber, EPDM rubber, and SBC rubber.

14. An article comprising a thermoplastic vulcanizate, the thermoplastic vulcanizate comprising:
from 60% by weight to 40% by weight of an elastomer, wherein the elastomer comprises at least 60% by weight of a conjugated diene rubber, selected from the group consisting of styrene butadiene rubber, polybutadiene rubber, polyisoprene rubber, and styrene/butene/styrene rubber, and blends thereof, and at from 0.1% by weight to 40% by weight of a saturated backbone rubber selected from the group consisting of EPM rubber, EPDM rubber, and SBC rubber;
from 40% by weight to 60% by weight of a polyolefin selected from the group consisting of isotactic polypropylene, syndiotactic polypropylene, and isotactic poly(1-butene); and
from 40 phr to 50 phr of carbon black.

15. The article of claim 14 selected from the group consisting of weather-stripping, seals, couplings, O-rings, mats, grips, and gaskets.

16. The article of claim 15, wherein the elastomer comprises from at least 50% to 99% by weight of styrene butadiene rubber and from 1% to less than 50% of EPDM rubber.

17. The article of claim 15, wherein the elastomer consists essentially of styrene butadiene rubber; and
wherein the thermoplastic vulcanizate further comprises an amount of a processing agent, selected form the group consisting of naphthenic oil and paraffinic oil, based on a vinyl weight fraction of the of copolymerized butadiene in the styrene butadiene rubber and a copolymerized butadiene weight fraction of the styrene butadiene rubber.

18. The article of claim 14, wherein the polyolefin comprises isotactic polypropylene, syndiotactic polypropylene, and isotactic poly(1-butene); and
wherein the amount of the processing agent is selected according to the formula BD°[66+(V-0.15)68], wherein BD is the weight fraction of copolymerized butadiene in the styrene butadiene rubber and V is the vinyl weight fraction of the copolymerized butadiene.

19. The article of claim 14, wherein the polyolefin consists essentially of polyethylene; and
wherein the amount of the processing agent is selected according to the formula BD°[46.7+(V-0.15)°68], wherein BD is the weight fraction of copolymerized butadiene in the styrene butadiene rubber and V is the vinyl weight fraction of the copolymerized butadiene.

20. The article of claim 14, wherein the article is selected from the group consisting of hood-to-radiator seals, rocker panels, hood-to-cowl seals, cowl seals, windshield seals, sunroof seals, roof line seals, window seals, trunk and tailgate seals, quarterlight seals, cutline seals, door seals, glass channels, vehicle moldings, belt line seals, and mirror gaskets.

21. The article of claim 14, wherein the thermoplastic vulcanizate possesses a ΔE of less than 1.0, wherein the ΔE is calculated based on an exposure to 2500 kJ of ultraviolet radiation at a rate of 30 kJ per day.
